(19) United States
(12) Patent Application Publication
(10) Pub. No.: US 2021/0229033 A1
(43) Pub. Date: Jul. 29, 2021

(54) POLYETHYLENIMINE COATED POLYMERIC BEADS

(71) Applicant: DOW GLOBAL TECHNOLOGIES LLC, Midland, MI (US)

(72) Inventors: Ji Guang Zhang, Shanghai (CN); Jian Zou, Shanghai (CN); Hongyu Chen, Shanghai (CN); Shaoguang Feng, Shanghai (CN); Wenbin Yao, Shanghai (CN); Haiying Li, Shanghai (CN); Xuemei Zhai, Shanghai (CN)

(73) Assignee: Dow Global Technologies LLC, Midland, MI (US)

(21) Appl. No.: 16/972,020

(22) PCT Filed: Jul. 4, 2018
(86) PCT No.: PCT/CN2018/094509

§ 371 Date: Dec. 4, 2020

(51) Int. Cl. B01D 53/72; C09D 179/02; B01D 53/02; B01J 20/28

(52) U.S. Cl. CPC B01D 53/72; C09D 179/02; B01D 53/02; B01J 20/28059; B01J 2220/62; B01J 20/28004; B01D 2253/202; B01D 2257/708; B01D 2258/06; B01J 20/28061

(57) ABSTRACT

Polyethylenimine coated polymeric beads comprising a polymer that comprises, based on the weight of the polymer, from 25% to 75% by weight of structural units of an acetoacetoxy or acetoacetamide functional monomer, and from 25% to 75% by weight of structural units of a polyvinyl monomer; the polyethylenimine having a number average molecular weight of 300 g/mol or more; the polyethylenimine coated polymeric beads having a specific surface area in the range of from 20 to 400 m²/g; a process of preparing the polyethylenimine coated polymeric beads; a gas filter device comprising the polyethylenimine coated polymeric beads as a filter medium; and a method of removing aldehydes from air containing aldehydes, comprising contacting the air with the polyethylenimine coated polymeric beads.

### FIELD OF THE INVENTION

The present invention relates to polyethylenimine coated acetoacetoxy or acetoacetamide functional polymeric beads and a process for preparing the same.

### INTRODUCTION

Aqueous dispersions comprising acetoacetoxy or acetoacetamide functional polymers have been known as aldehyde abatement materials in coating applications. However, hydrolysis of the acetoacetoxy or acetoacetamide functional groups in these polymers tend to occur in water during storage in containers, which causes an unsafe buildup of pressure resulting in safety concerns. Thus, acetoacetoxy or acetoacetamide functional polymers in the aqueous dispersions usually contain a low content of acetoacetoxy or acetoacetamide functional groups. For example, the content of acetoacetoxy or acetoacetamide functional monomers used for preparing these functional polymers usually cannot be higher than 10% by weight of total monomers. To prohibit hydrolysis of acetoacetoxy or acetoacetamide functional polymers in aqueous dispersions while increasing the content of acetoacetoxy or acetoacetamide functional groups, such aqueous dispersions have to be further exposed to a drying process after emulsion polymerization thus to obtain polymer powders for storage, but the drying process involves additional facility costs. In addition, these polymer powders typically have a particle size of from 50 nanometers (nm) to 1 micrometer and may not be suitable for some applications where larger polymer particles are required.

Aldehyde abatement materials are also desirable in other applications, such as gas filter devices. Conventional gas filter devices such as air conditioners and air purifiers typically use activated carbon as a filter medium. Formaldehyde abatement by activated carbon is physical adsorption, thus formaldehyde abatement rate of activated carbon tends to decrease along the service life of a product containing activated carbon. There is always a need to further improve formaldehyde abatement capacity and formaldehyde abatement rate of these conventional gas filter devices.

Therefore, it is desirable to develop novel polymers suitable for removing aldehydes, particularly gaseous aldehydes, which provide better aldehyde abatement properties than activated carbon and have limited impacts on existing processing facilities.

### SUMMARY OF THE INVENTION

The present invention provides novel polyethylenimine coated polymeric beads comprising a specific acetoacetoxy or acetoacetamide functional polymer. The polyethylenimine coated polymeric beads of the present invention show surprisingly higher formaldehyde abatement capacity and/or higher formaldehyde abatement rate, as compared to activated carbon or polymeric beads without treatment by polyethylenimine. The polyethylenimine coated polymeric beads are useful to be used as a filter medium for gas filter devices.

In a first aspect, the present invention provides polyethylenimine coated polymeric beads comprising a polymer, wherein the polymer comprises, based on the weight of the polymer,

from 25% to 75% by weight of structural units of an acetoacetoxy or acetoacetamide functional monomer, and

from 25% to 75% by weight of structural units of a polyvinyl monomer;

wherein the polyethylenimine has a number average molecular weight of 300 g/mol or more; and

wherein the polyethylenimine coated polymeric beads have a specific surface area in the range of from 20 to 400 m²/g.

In a second aspect, the present invention provides a process for preparing the polyethylenimine coated polymeric beads of the first aspect. The process comprises,

(i) suspension polymerization of monomers in the presence of a porogen, wherein the monomers comprise, based on the total weight of monomers,

from 25% to 75% by weight of an acetoacetoxy or acetoacetamide functional monomer, and from 25% to 75% by weight of a polyvinyl monomer; and

(ii) contacting the obtained polymer from step (i) with a polyethylenimine to give the polyethylenimine coated polymeric beads;

wherein the polyethylenimine has a number average molecular weight of 300 g/mol or more; and

wherein the polyethylenimine coated polymeric beads have a specific surface area in the range of from 20 to 400 m²/g.

In a third aspect, the present invention provides a gas filter device comprising the polyethylenimine coated polymeric beads of the first aspect as a filter medium.

In a fourth aspect, the present invention provides a method of removing aldehydes from air containing aldehydes, comprising contacting the air with the polyethylenimine coated polymeric beads of the first aspect.

### DETAILED DESCRIPTION OF THE INVENTION

“Acrylic” as used herein includes (meth)acrylic acid, (meth)alkyl acrylate, (meth)acrylamide, (meth)acrylonitrile and their modified forms such as (meth)hydroxyalkyl acrylate. Throughout this document, the word fragment “(meth)acryl” refers to both “methacryl” and “acryl”. For example, (meth)acrylic acid refers to both methacrylic acid and acrylic acid, and methyl (meth)acrylate refers to both methyl methacrylate and methyl acrylate.

A “bead” is characterized by its average particle size of at least 20 micrometers (μm). The average particle size herein refers to the number average particle size determined by the test method described in the Examples section below.

The term “polyethylenimine coated polymeric beads” means at least a portion of the surface of the polymeric beads is coated by a polyethylenimine, so that the obtained polymeric beads bear pendant enamine moieties resulting from the reaction of pendant acetoacetyl moieties with the polyethylenimine.

The term “structural units” used herein, also known as polymerized units, of the named monomer refers to the remnant of the monomer after polymerization. For example, a structural unit of methyl methacrylate is as illustrated:

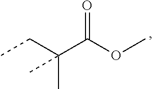

where the dotted lines represent the points of attachment of the structural unit to the polymer backbone.

The polyethylenimine coated polymeric beads of the present invention comprise a polymer. The polymer useful in the present invention is a polymerization product of monomers comprising from 25% to 75% by weight of at least one acetoacetoxy or acetoacetamide functional monomer and from 25% to 75% by weight of at least one polyvinyl monomer, based on the total weight of monomers. That is, the polymer comprises structural units of at least one acetoacetoxy or acetoacetamide functional monomer and structural units of at least one polyvinyl monomer.

The polymer useful in the present invention comprises structural units of one or more acetoacetoxy or acetoacetamide functional monomers. The acetoacetoxy or acetoacetamide functional monomers are monomers having one or more acetoacetyl functional groups represented by:

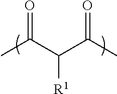

wherein R¹ is hydrogen, an alkyl having 1 to 10 carbon atoms, or phenyl.

Examples of suitable acetoacetoxy or acetoacetamide functional groups include

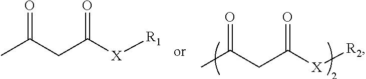

wherein X is O or N, R₁ is a divalent radical and R₂ is a trivalent radical, that attach the acetoacetoxy or acetoacetamide functional group to the backbone of the polymer. The acetoacetoxy or acetoacetamide functional monomers preferably have the structure of formula (I):

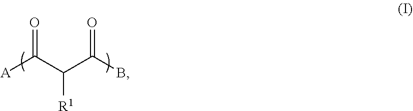

wherein A is either

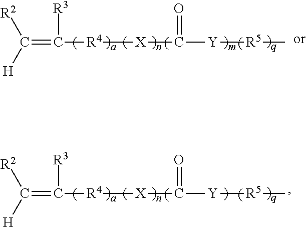

wherein R¹ is selected from H, alkyl having 1 to 10 carbon atoms, and phenyl; R² is selected from H, alkyl having 1 to 10 carbon atoms, phenyl, halo, CO₂CH₃, and CN; R³ is selected from H, alkyl having 1 to 10 carbon atoms, phenyl, and halo; R⁴ is selected from alkylene having 1 to 10 carbon atoms and phenylene; wherein R⁵ is selected from alkylene having 1 to 10 carbon atoms and phenylene; wherein a, m, n, and q are independently selected from 0 and 1; wherein each of X and Y is selected from —NH— and —O—; and B is selected from A, alkyl having 1 to 10 carbon atoms, phenyl, and heterocyclic groups.

The acetoacetoxy or acetoacetamide functional monomer useful for preparing the polymer can be an ethylenically unsaturated acetoacetoxy or acetoacetamide functional monomer, that is, a monomer having an ethylenic unsaturation and one or more acetoacetoxy or acetoacetamide functional group. Preferred acetoacetoxy or acetoacetamide functional monomers include acetoacetoxyalkyl (meth)acrylates such as acetoacetoxyethyl methacrylate (AAEM), acetoacetoxyethyl acrylate, acetoacetoxypropyl methacrylate, acetoacetoxybutyl methacrylate, and 2,3-di(acetoacetoxy)propyl methacrylate; allyl acetoacetate, acetoacetamides and combinations thereof. The polymer may comprise, by weight based on the weight of the polymer, 25% or more, 30% or more, 35% or more, 40% or more, 45% or more, or even 50% or more, and at the same time, 75% by weight or less, 70% or less, 68% or less, 65% or less, 60% or less, or even 55% or less of structural units of the acetoacetoxy or acetoacetamide functional monomer.

The polymer useful in the present invention may comprise structural units of one or more polyvinyl monomers. Polyvinyl monomers are monomers having two or more ethylenically unsaturated sites per molecule, for example, di-functional or tri-functional polyvinyl monomers, which are suitable as crosslinkers to form a crosslinked polymer. A crosslinked polymer as used herein refers to a polymer polymerized from monomers containing a polyvinyl monomer. The polyvinyl monomer can be a polyvinyl aromatic monomer, a polyvinyl aliphatic monomer, and mixtures thereof. Examples of suitable polyvinyl monomers include polyvinylbenzene monomers such as divinylbenzene, trivinyl benzene and divinylnaphthalene and diallyl phthalate; allyl (meth)acrylate; polyalkylene glycol di(meth)acrylate such as tripropylene glycol dimethacrylate, diethylene glycol dimethacrylate, ethylene glycol di(meth)acrylate, 1,6-hexanediol di(meth)acrylate, 1,3-butylene glycol dimethacrylate and 1,4-butylene glycol di(meth)acrylate; tri-functional (meth)acrylates such as trimethylolpropane trimethacrylate; and mixtures thereof. Preferred polyvinyl monomers include divinylbenzene, trimethylolpropane trimethacrylate and mixtures thereof. The polymer may comprise, by weight based on the weight of the polymer, 25% or more, 30% or more, 35% or more, 40% or more, 45% or more, or even 50% or more, and at the same time, 75% or less, 70% or less, 68% or less, 65% or less, 60% or less, or even 55% by weight or less of structural units of the polyvinyl monomer. In some embodiments, the polymer comprises structural units of tri-functional (meth)acrylates such as trimethylolpropane trimethacrylate, in an amount of 30% or more, 31% or more, 32% or more, 33% or more, 34% or more, 35% or more, 38% or more, or even 40% or more, by weight based on the total weight of the structural units of the polyvinyl monomers.

The polymer useful in the present invention may also comprise structural units of one or more monovinyl aromatic monomers. The monovinyl aromatic monomers may include styrene; α-substituted styrene such as methyl styrene, ethyl styrene, t-butyl styrene, and bromo styrene; vinyltoluenes; ethyl vinylbenzenes; vinylnaphthalenes; heterocyclic monomers such as vinylpyridine and 1-vinylimidazole; and mixtures thereof. Preferred monovinyl aromatic monomers include styrene, ethyl vinylbenzene, and mixtures thereof; and more preferably styrene. Mixtures of monovinyl aromatic monomers can be employed. The polymer may comprise, by weight based on the weight of the polymer, from zero to 50% of structural units of the monovinyl aromatic monomer, for example, 30% or less, 20% or less, 10% or less, or even 5% or less of structural units of the monovinyl aromatic monomer.

The polymer useful in the present invention may also include structural units of one or more monovinyl aliphatic monomers. Said monovinyl aliphatic monomers expressly exclude the acetoacetoxy or acetoacetamide functional monomer described above. The monovinyl aliphatic monomer may include esters of (meth)acrylic acids, esters of itaconic acid, esters of maleic acid, (meth)acrylonitrile, and α,β-ethylenically unsaturated carboxylic acids and/or their anhydrides and mixtures thereof. Suitable α,β-ethylenically unsaturated carboxylic acids and/or their anhydrides may include (meth)acrylic anhydride, maleic anhydride, acrylamido-2-methylpropanesulfonic acid (AMPS), acrylic acid, methyl acrylic acid, crotonic acid, acyloxypropionic acid, maleic acid, fumaric acid, itaconic acid, or mixtures thereof. The esters of (meth)acrylic acids can be C₁-C₁₈-, C₄-C₁₂-, or C₈-C₁₀-alkyl esters of (meth)acrylic acid including, for example, methyl acrylate, ethyl acrylate, butyl acrylate, 2-ethylhexyl acrylate, decyl acrylate, lauryl acrylate, methyl methacrylate, butyl methacrylate, isodecyl methacrylate, 2-hydroxyethyl methacrylate, lauryl methacrylate and mixtures thereof. Preferred monovinyl aliphatic monomers include methyl methacrylate, acrylonitrile, ethyl acrylate, 2-hydroxyethyl methacrylate and mixtures thereof. The polymer may comprise, by weight based on the weight of the polymer, from zero to 40% of structural units of the monovinyl aliphatic monomer, for example, less than 30%, less than 20%, less than 10%, less than 5%, or less than 1% of structural units of the monovinyl aliphatic monomer. The polymer is preferably substantially free of structural units of the monovinyl aliphatic monomer.

In some embodiments, the polymer useful in the present invention comprises, by weight based on the weight of the polymer, from 30% to 70% of structural units of the acetoacetoxy or acetoacetamide functional monomer, from 70% to 30% of structural units of the polyvinyl monomer, from 0 to 20% of structural units of the monovinyl aromatic monomer, and from 0 to 20% of structural units of the monovinyl aliphatic monomer.

In a preferred embodiment, the polymer useful in the present invention comprises, by weight based on the weight of the polymer, from 45% to 65% of structural units of the acetoacetoxy or acetoacetamide functional monomer, from 35% to 55% of structural units of the polyvinyl monomer, and from 0 to 20% of structural units of the monovinyl aromatic monomer.

In other embodiments, the polymer comprises structural units of the acetoacetoxy or acetoacetamide functional monomer and the rest being the polyvinyl monomer. Preferably, the polymer comprises, by weight based on the weight of the polymer, from 25% to 75%, from 30% to 70%, or from 45% to 65% of structural units of the acetoacetoxy or acetoacetamide functional monomer, and the rest being the structural units of the polyvinyl monomer.

The polyethylenimine useful in the present invention may have the structure of formula (II),

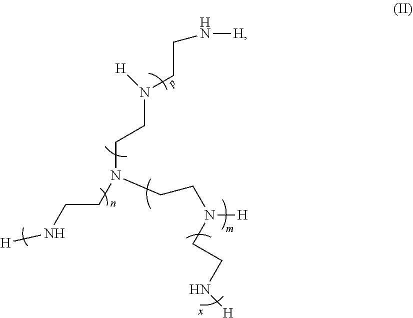

where n, m, p, and x are each independently an integer of from 0 to 1,000, provided that n+m+p+x>5. Preferably, n, m, p, and x are each independently an integer in the range of from 6 to 500, from 10 to 400, from 15 to 300, or from 20 to 200. Preferably, n+m+p+x is an integer in the range of from 6 to 4,000, from 10 to 1,000, or from 15 to 500.

The polyethylenimine useful in the present invention may have a number average molecular weight of 300 grams per mole (g/mol) or more, 400 g/mol or more, 500 g/mol or more, 800 g/mol or more, 1,000 g/mol or more, 1,200 g/mol or more, 1,500 g/mol or more, 1,700 g/mol or more, 2,000 g/mol or more, or even 2,200 g/mol or more, and at the same time, 1,000,000 g/mol or less, 750,000 g/mol or less, 500,000 g/mol or less, 250,000 g/mol or less, 100,000 g/mol or less, 50,000 g/mol or less, 25,000 g/mol or less, 10,000 g/mol or less, 8,000 g/mol or less, 5,000 g/mol or less, 4,000 g/mol or less, or even 3,000 g/mol or less. The molecular weight of polyethylenimines can be measured by Gel Permeation Chromatography (GPC) according to the test method described in the Examples section. The process for preparing the polyethylenimine coated polymeric beads of the present invention may comprise step (i) suspension polymerization of the acetoacetoxy or acetoacetamide functional monomer and the polyvinyl monomer, and optionally, the monovinyl aromatic monomer and/or the monovinyl aliphatic monomers described above in the presence of a porogen, and step (ii) contacting the obtained polymer from step (i) with the polyethylenimine to obtain the polyethylenimine coated polymeric beads. The polymer useful in the present invention may be prepared by suspension polymerization of the monomers described above. The polymer comprises the monomers in polymerized form, that is, structural units of the monomers comprising the acetoacetoxy or acetoacetamide functional monomer, the polyvinyl monomer, and optionally, the monovinyl aromatic monomer and/or the monovinyl aliphatic monomer. Total weight concentration of the monomers used for preparing the polymer is equal to 100%. Weight concentration of each monomer in the monomers for preparing the polymer is substantially the same as that of the structural units of such monomer in the polymer. For example, monomers used for preparing the polymer may comprise, based on the total weight of monomers, from 25% to 75% by weight of the acetoacetoxy or acetoacetamide functional monomer, and from 25% to 75% by weight of the polyvinyl monomer.

Suspension polymerization for preparing the polyethylenimine coated polymeric beads may be conducted in the presence of one or more porogens. The suspension polymerization is typically conducted by forming a suspension of monomers within an agitated, continuous suspending medium in the presence of one or more porogens, followed by polymerization of the monomers described above for forming the polymer, that is, the polymerization product of these monomers. Porogens are inert solvents that are suitable for forming pores and/or displacing polymer chains during polymerization. A porogen is one that dissolves the monomers being polymerized but does not dissolve the polymer obtained therefrom. Examples of suitable porogens include aliphatic hydrocarbon compounds such as heptane and octane, aromatic compounds such as benzene, toluene, and xylene, halogenated hydrocarbon compounds such as dichloroethane and chlorobenzene, and linear polymer compounds such as polystyrene. These compounds may be used alone or as a mixture of two or more thereof. Preferred porogens include diisobutyl ketone and toluene. The amount of the porogen used in the present invention may be from 10 to 500 parts by weight, from 30 to 300 parts by weight, or from 50 to 200 parts by weight, per 100 parts by weight of total monomers for preparing the polymer.

Suspension polymerization is well known to those skilled in the art and may comprise suspending droplets of the monomers and of the porogen in a medium in which neither are soluble. This may be accomplished by adding the monomers and the porogen with other additives to the suspending medium (preferably, water) which contains a stabilizer. The monomers may be first mixed with the porogen and other additions (e.g., a free radical initiator) to form an oil phase, and then the oil phase may be added into a water phase. The water phase may comprise a stabilizer, and optionally, an inorganic salt such as sodium chloride, potassium chloride, sodium sulphate and mixtures thereof; an inhibitor such as 2,2,6,6-tetramethylpiperidin-1-oxyl (“TEMPO”), 4-hydroxy-2,2,6,6-tetramethylpiperidin-1-oxyl (“4-Hydroxy-TEMPO”); and mixtures thereof. The monomers can be suspended as droplets often of diameter from 1 μm to 2,000 μm in water. The suspension polymerization may be conducted under nitrogen (N2) atmosphere. The suspension polymerization is typically conducted under agitation at a speed of from 5 to 1,000 revolutions per minute (rpm), from 20 to 600 rpm, or from 50 to 300 rpm. Temperature suitable for suspension polymerization may be in the range of from 20° C. to 99° C. or in the range of from 60 to 90° C. Time duration for suspension polymerization may be in the range of from 1 to 30 hours, or in the range of from 3 to 20 hours.

The stabilizers useful in suspension polymerization are compounds useful for preventing agglomeration of monomer droplets. Examples of suitable stabilizers include polyvinyl alcohol (PVA), polyacrylic acid, polyvinyl pyrrolidone, polyalkylene oxide such as polyethylene glycol, gelatin, a cellulosic such as hydroxyethyl cellulose, methyl cellulose, carboxymethyl methyl cellulose, and hydroxypropyl methylcellulose (HPMC), poly(diallyldimethylammonium chloride) (PDAC) and mixtures thereof. Preferred suspension stabilizers include polyvinyl alcohol, gelatin, poly(diallyldimethylammonium chloride) and mixtures thereof. The stabilizer may be added in one shot or in at least two additions. The stabilizer may be used in an amount of from 0.01% to 3% by weight or from 0.1% to 2% by weight, based on the total weight of the monomers.

Suspension polymerization may be conducted in the presence of a free radical initiator to initiate the polymerization. Examples of suitable free radical initiators include organic peroxides such as benzoyl peroxide, lauroyl peroxide, dioctanoyl peroxide and mixtures thereof, organic azo compounds including azobisisobutyronitrile such as 2,2′-azobisisobutyronitrile and 2,2′-azobis(2,4-dimethylvaleronitrile) and mixtures thereof. Preferred free radical initiators include benzoyl peroxide, lauroyl peroxide, and mixtures thereof. The free radical initiators may be used typically at a level of from 0.01% to 5% by weight or from 0.1% to 2% by weight, based on the total weight of the monomers for preparing the polymer. After completion of suspension polymerization, the obtained polymer, typically in the shape of beads, may be isolated by filtration.

The process for preparing the polyethylenimine coated polymeric beads further comprises step (ii) contacting and/or reacting the polymeric beads obtained from suspension polymerization (i.e., step (i)) with the polyethylenimine to obtain the polyethylenimine coated polymeric beads. Contacting and/or reacting the polyethylenimine with the polymeric beads is preferably conducted at a temperature of from 25 to 100° C., from 60 to 80° C., or from 40 to 90° C. The polyethylenimine may be used in an amount of from 0.1% to 15%, from 0.5% to 12%, from 1% to 10%, from 1.5% to 8%, from 2% to 7%, or from 3% to 6%, by weight based on the weight of the polymer.

The obtained polyethylenimine coated polymeric beads of the present invention may have a number average particle size of 20 μm or more, 30 μm or more, 40 μm or more, 50 μm or more, 80 μm or more, 90 μm or more, 100 μm or more, 120 μm or more, 140 μm or more, 150 μm or more, 160 μm or more, or even 200 μm or more. The number average particle size of the polyethylenimine coated polymeric beads may be 5,000 μm or less, 4,500 μm or less, 4,000 μm or less, 3,500 μm or less, 3,000 μm or less, 2,500 μm or less, 2,000 μm or less, 1,800 μm or less, 1,500 μm or less, 1,200 μm or less, 1,000 μm or less, 800 μm or less, 700 μm or less, or even 600 μm or less. The number average particle size of the polyethylenimine coated polymeric bead can be determined according to the test methods described in the Examples section below. The polyethylenimine coated polymeric beads may be further processed and/or treated into various shapes.

The polyethylenimine coated polymeric beads of the present invention may be porous crosslinked polymeric beads. The polyethylenimine coated polymeric beads may have a specific surface area of 20 m²/g or more, 25 m²/g or more, 30 m²/g or more, 40 m²/g or more, 45 m²/g or more, 50 m²/g or more, 60 m²/g or more, 70 m²/g or more, 80 m²/g or more, 85 m²/g or more, 90 m²/g or more, 100 m²/g or more, 105 m²/g or more, 110 m²/g or more, 115 m²/g or more, 120 m²/g or more, or even 130 m²/g or more. The polymeric bead may have a specific surface area of 400 m²/g or less, 380 m²/g or less, 350 m²/g or less, 340 m²/g or less, 300 m²/g or less, 250 m²/g or less, 200 m²/g or less, 150 m²/g or more, or even 140 m²/g or less. Values of the specific surface area per unit weight of the polyethylenimine coated polymeric beads (m² per gram of the polymeric beads) were determined by the nitrogen adsorption method in which dried and degassed samples were analyzed on an automatic volumetric sorption analyzer. The instrument works on the principle of measuring the volume of gaseous nitrogen adsorbed by a sample at a given nitrogen partial pressure. The volumes of gas adsorbed at various pressures are used in the BET (Brunauer-Emmett-Teller) model for calculation of the specific surface area of the sample.

The present invention also relates to a method of removing aldehydes from air containing aldehydes, comprising contacting the air with the polyethylenimine coated polymeric beads of the present invention. The polyethylenimine coated polymeric beads cause aldehyde abatement (i.e., reduction). Examples of aldehydes include formaldehyde, acetaldehyde, acrolein, propionaldehyde and mixtures thereof. Without being bound by theory, it is believed that the polyethylenimine coated polymeric beads contain acetoacetyl moieties, enamine moieties, and amine moieties. The reaction of these moieties with aldehydes is irreversible (i.e., a chemical reaction) as compared to physically absorption of aldehydes by those conventional absorbers such as activated carbon. The polyethylenimine coated polymeric beads of the present invention can provide higher formaldehyde abatement capacity and/or higher formaldehyde abatement rate even after aging (for example, 85° C./85% humidity for 19 days), as compared to activated carbon or polymeric beads without being coated by a polyethylenimine. The formaldehyde abatement capacity and formaldehyde abatement rate may be measured according the test methods described in the Examples section below. Preferably, the polyethylenimine coated polymeric beads can provide both higher formaldehyde abatement capacity and higher formaldehyde abatement rate than activated carbon.

The polyethylenimine coated polymeric beads of the present invention are useful in various applications for the removal of aldehydes including, for example, elastomers, plastics, adhesives, filter tips of cigarettes, air conditioners and air purifiers. The polyethylenimine coated polymeric beads can be used as a filter medium useful for the removal of a gaseous aldehyde from a gas such as air. Gaseous aldehydes may include formaldehyde, acetaldehyde, acrolein, propionaldehyde and mixtures thereof. The polyethylenimine coated polymeric beads of the present invention may be used in combination with activated carbon.

The present invention also relates to a gas filter device comprising the polyethylenimine coated polymeric beads as a filter medium. The gas filter device may include, for example, filter beds, filter cartridges, tobacco smoke filters, high efficiency particulate air (HEPA) filters, ultralow penetration air (ULPA) filters and automotive cabin air filters (CAFs). The gas filter device can be used in various applications such as air purifiers such as in-car air purifiers and household air purifier, and air conditioners.

### EXAMPLES

Some embodiments of the invention will now be described in the following Examples, wherein all parts and percentages are by weight unless otherwise specified.

Acetoacetoxyethyl methacrylate (AAEM) is available from Eastman Chemical.

Divinyl benzene (DVB) and trimethylolpropane trimethacrylate (TRIM) both used as crosslinkers, diisobutyl ketone (DIBK) used as a porogen, and lauroyl peroxide (LPO) and benzoyl peroxide (BPO) both used as initiators, are all available from Sinopharm Chemical Reagent Co., Ltd. (SCRC).

An aqueous solution of poly(diallyldimethylammonium chloride) (PDAC) (20% by weight), available from The Dow Chemical Company, is used as a stabilizer.

Hydroxypropyl methylcellulose (HPMC), available from The Dow Chemical Company, is used as a stabilizer.

Polyethylenimines (PEIs), available from SCRC. Co. Ltd., have different number average molecular weight as determined by GPC with polyethylene glycol standards of about 1810 g/mol (hereinafter “PEI 1810”) and about 2275 g/mol (hereinafter “PEI 2275”).

Ammonia (NH₃.H₂O, 27% active in water) is available from SCRC. Co. Ltd.

AMP-95 (95% active in water), available from SCRC. Co. Ltd., is 2-amino-2-methyl-1-propanol with a boiling point of 165° C.

The following standard analytical equipment and methods are used in the Examples.

### Fourier Transform Infrared Spectroscopy (FTIR)

Conditions for FTIR analysis were as follows: Spectrometer: Nicolet 6700 FTIR; ATR accessory, Smart DuraSamplIR Diamond ATR; Scan range: 4000-650 cm⁻¹; Resolution: 4 cm⁻¹; Apodization: Happ-Genzel; Phase correction: Mertz; and Detector: DTGS KBr.

### Particle Size

For polymeric beads with particle size smaller than 1 millimeter (mm), the particle size of the polymeric beads was determined using a Beckman Coulter RapidVue optical microscope. The particle size was determined by averaging particle size of over 1,500 polymeric beads and the number average particle size was recorded.

For ultra-large beads equal to or larger than 1 mm, Leica DM4 M optical microscope was used to determine the particle size. Matlab R2017b software was used to analyze the particle images. The number average particle size was calculated by averaging particle size of 3537 particles.

### Specific Surface Area (BET Method)

Specific surface areas of polymeric beads were determined by N₂ adsorption-desorption isotherms on a Micrometric ASAP 2010 apparatus. Samples were dried at 50° C. overnight prior to adsorption studies. The volume of gas adsorbed to the surface of the polymeric beads was measured at the boiling point of nitrogen (−196° C.). The amount of adsorbed gas was correlated to the total surface area of the polymeric beads including pores on the surface. Specific surface area calculations were carried out using the BET method.

### Molecular Weight Measurement

GPC analysis was performed generally by Agilent 1200. A sample was dissolved in 0.1 mol/L sodium nitrate in deionized (DI) water with a concentration of about 4 mg/mL and then filtered through 0.45 μm Polyvinylidene Fluoride (PVDF) filter prior to GPC analysis. The GPC analysis is conducted using the following conditions:

Column: One TSKgel guard column PWXL (6.0 mm*40 mm, 12 μm) and One TSK gel G3000 PWxl-CP columns (7.8 mm*30 cm, 7 μm) in tandem; column temperature: 25° C.; mobile phase: 0.1 mol/L sodium nitrate in DI water; flow rate: 0.8 mL/minute; Injection volume: 100 L; detector: Agilent Refractive Index detector, 25° C.; and calibration curve: PL Polyethylene Glycol standards (Part No.: 2070-0100) with molecular weights ranging from 21300 to 106 g/mol, using polynom 3 fitness.

### Formaldehyde Abatement Rate Test and Clean Air Delivery Rate Measurement

The test of formaldehyde abatement rate of a sample was conducted in a mini-chamber system where formaldehyde was circulated in the system and passed through a testing tube. During the test, the formaldehyde concentration decreased gradually with testing time as formaldehyde was consumed by the sample. Detailed testing procedure was as follows:

A 4 liter glass chamber (available from Shanghai Hongjing instrument Co., Ltd.) was used for the test and a plastic tube was connected to the outlet of the chamber. A formaldehyde detector (GT903-CH₂O available from Keernuo Co., Ltd., Shenzhen, China; formaldehyde detecting range: 0.01 mg/m³-13.4 mg/m³), a testing tube, an air pump, and a micro-flow controller were connected in sequence using plastic tubes, and finally connected to the inlet of the chamber to form a cycling mini-chamber system.

At the beginning of the test, an aliquot of a formaldehyde solution (about 400 ppm formaldehyde in a mixture of acetonitrile (ACN) and water) was injected into the glass chamber directly. Then the air pump started to circulate air inside the system at a flow rate of 500 mL/min to allow formaldehyde to equilibrate in the mini-chamber system. The initial formaldehyde concentration in the mini-chamber system was about 0.9 mg/m³ (milligram formaldehyde per cubic meter of air). Then a test sample was put in the testing tube quickly and formaldehyde-containing air was circulated in the system at a constant flow rate (500 mL/min). Formaldehyde concentrations at different time points were recorded using the formaldehyde detector. Results were presented as percentage of formaldehyde consumed in the mini-chamber system as function of testing time.

Clean Air Delivery Rate (CADR) measures the volume of clean air that is produced by a sample per minute. CADR values of different samples were tested using the mini-chamber system described above, and measured using the equations below:

Q=60×k×V (i)

where Q is CADR value (m³/h), V is the volume of the mini-chamber (m³), and k is the decay constant (min⁻¹) determined according to equation (ii),

$$- k = \frac{( {\sum }_{i = 1}^{a} {t}_{i} ln {c}_{{t}_{i}} ) - \frac{1}{n} ( {\sum }_{i = 1}^{n} {t}_{i} ) ( {\sum }_{i = 1}^{n} ln {c}_{{t}_{i}} )}{( {\sum }_{i = 1}^{n} {t}_{i}^{2} ) - \frac{1}{n} {( {\sum }_{i = 1}^{n} {t}_{i} )}^{2}} , \qquad ( ii )$$

where k is the decay constant (min⁻¹); tᵢ is the sampling time (min); lncₜᵢ is the natural logarithms value of formaldehyde concentration of the sampling time of tᵢ; and n refers to the total number of sampling points. The higher the CADR value, the faster the sample's formaldehyde abatement rate.

### Formaldehyde Abatement Capacity Test (Testing Tube Method)

The formaldehyde abatement capacity test was conducted by continuously feeding formaldehyde to a testing tube and real-time monitoring of formaldehyde concentrations at the outlet of the testing tube. The less formaldehyde passed through the testing tube (i.e., the lower formaldehyde concentration at the outlet of the testing tube) for the same time period, the better formaldehyde abatement capacity of the sample. Detailed testing procedure was as follows: An air pump (KDY-F air pump available from Jiang Su Keyuan instrument Co., Ltd.,

China) was connected to a 3-way connector via a plastic tube. The other two ends of the 3-way connector were connected to a syringe pump (RSP04-A available from Ristron Co., Ltd.) for injecting a formaldehyde solution (about 400 ppm formaldehyde in an ACN/water mixture), and a micro-flow controller (21-1-00-0-1000-KM9015 available from Alicat Co., Ltd.), respectively. The flow rate of the micro-flow controller was set at 500 mL/min. The micro-flow controller was further connected to the inlet of a 3 mL testing tube (available from Jingrong Electrical Materials Co., Ltd., Jiangsu, China). The outlet of the testing tube was connected to a formaldehyde detector (GT903-CH₂O formaldehyde detector from Keernuo Co., Ltd., formaldehyde detecting range: 0.01-13.4 mg/m³). The speed of the syringe pump was set at an appropriate value to ensure the formaldehyde concentration in the air flow at the inlet of the testing tube at about 0.25 mg/m³ as measured by the formaldehyde detector.

A test sample was put into the 3 mL testing tube. A frit (SBEQ-CR03PE available from Anpel Co., Ltd., China.) was installed at the bottom of the cartridge to avoid sample leakage from the cartridge. The outlet of the testing tube was connected to the formaldehyde detector to monitor the concentration of formaldehyde passed through the testing tube. During the test, the formaldehyde concentration (mg/m³) in the air flow at the outlet of the testing tube was recorded periodically.

Total amount of abated formaldehyde was measured using equation (iii) below:

Fₜ=Σᵢ₌₁ⁿ(C₀−Cᵢ)×Vₐ×T (iii),

where:

Fₜ is the total amount of formaldehyde abated by the sample in the testing tube (μg),

C₀ is the starting formaldehyde concentration at 0 min (μg/m³),

Cᵢ is the average formaldehyde concentration for the i^{th} time slot (time slot refers to every 20 minutes) (μg/m³),

Vₐ is the air flow rate that pass through the testing tube (m³/min),

T is the time slot value and equals to 20 minutes, and

i is the number of the time slot, ranging from 1 to n.

### Examples (Exs) 1-7

Exs 1-7 were conducted according to the following two steps, based on formulations and conditions given in Table 1, respectively:

Step 1: Polymerization to Prepare Polymeric Beads

A 4 L, three neck reactor equipped with a condenser, a mechanical stirrer and an inlet for nitrogen (N2) was fed with DI water (1,500 g). Then stabilizers including 10 g of aqueous PDAC solution (20% by weight) and 0.8 g of HPMC solids were added into the reactor. The reactor was heated to 95° C. under a gentle N2 flow. A clear solution was obtained.

In a separate container, an oil phase composition as given in Table 1 was prepared by mixing monomers, an initiator and a porogen, and then agitated until a clear solution was obtained. The resultant oil phase was added into the reactor under a stirring rate as shown in Table 1. The reactor was maintained at 50° C. for 30 minutes before heated to 75° C. The reaction proceeded for 7 hours at 75° C. Then a Dean-Stark apparatus was equipped onto the reactor and the temperature was ramped to 100° C. within 1 hour and kept at 100° C. for one more hour until no more porogen condensed in the Dean-Stark tube.

Step 2: Amine Modification of Polymeric Beads

The polymeric beads obtained from step 1 were further washed with hot DI water at 80° C. by adding hot water at the same volume of beads into the reactor, stirring for half an hour and then removing the water out of the reactor via a siphon tube. Then the reactor was cooled to room temperature.

To modify the polymeric beads, a solution of PEI in water (50% by weight) as given in Table 1 was drop wise added into the reactor under mild stirring. After the addition of the amine solution, the mixture was further stirred for an hour at 80° C. The resultant amine modified beads were then collected by filtering through a stainless steel sieve with mesh size of 325 mesh (or 44 μm). The wet beads were left in sieve overnight and then further dried in an oven at 104° C. for 12 hours.

### Ex 8

Ex 8 was conducted according to the following two steps:

Step 1: Polymerization to Prepare Polymeric Beads

A 4 L, three neck reactor equipped with a condenser, a mechanical stirrer and an inlet for N₂ was fed with DI water (1,500 g). Then stabilizers including 10 g of an aqueous PDAC solution (20% by weight), and 0.8 g of HPMC solids were added into the flask. The reactor was heated to 95° C. under a gentle N2 flow. A clear solution was obtained.

PS foam (30 g) was teared into small pieces. These small PS foam pieces were then mixed with components (monomers, an initiator, and a porogen) in an oil phase composition as given in Table 1. The resultant mixture was agitated until a clear solution was obtained. The resultant oil phase was added into the reactor under a stirring rate as given in Table 1 and the reactor was maintained at 50° C. for 30 minutes before heated to 75° C. The reaction proceeded for 7 hours at 75° C. Then a Dean-Stark apparatus was equipped onto the reactor and the temperature was ramped to 100° C. within 1 hour and kept at 100° C. for one more hour until no more porogen condensed in the Dean-Stark tube.

Step 2: Amine Modification of Polymeric Beads

The obtained polymeric beads were further treated according to the same procedure as described in the step 2 of Ex 1.

### Comparative (Comp) Ex A

Comp Ex A was conducted according to the same procedure as Ex 1, except that the oil phase composition used was as given in Table 1 and the step of amine modification was omitted.

### Comp Ex B-1

Activated carbon (AC) with powder-like shape with 200-700 μm in diameter and a specific surface area of 385 m²/g, available from Azure Co. Ltd., was used as a control sample to evaluate for formaldehyde (FA) abatement rate and abatement capacity of Ex 1 to Ex 7.

### Comp Ex B-2

AC with rod-like shape with 1 mm in diameter and 1 to 3 mm in length and a specific surface area of 356 m²/g, available from Jiangsu Litong Co. Ltd., was used as a control sample to evaluate for FA abatement rate and abatement capacity of Ex 8.

### Comp Ex C

Comp Ex C was conducted according to the same procedure as Ex 1, except that the oil phase composition used was as given in Table 1 and the PEI solution was replaced by ammonia in the step 2 of amine modification.

### Comp Ex D

Comp Ex D was conducted according to the same procedure as Ex 1, except that the oil phase composition used was as given in Table 1 and the PEI solution was replaced by AMP-95 in the step 2 of amine modification.

FTIR analysis of the polymeric beads of Ex 1 showed the following peaks: 1719 cm⁻¹ (carbonyl group in acrylic), 1649 cm⁻¹ (enamine structure resulting from reaction of carbonyl group in acetoacetate (AcAc) group with amine group), 1603 cm⁻¹ (carbon-carbon double bond in enamine structure), and 1444 cm⁻¹ (methyl group in PEI raw materials). The peaks at 1649 cm⁻¹ and 1603 cm⁻¹ were indicators of formation of enamine bonds.

Properties of the above beads were evaluated according to the test methods described above and results are given in Table 2.

TABLE 1
Compositions and Conditions for Preparing Polymeric Beads

| Oil phase | | | | | | | | | | Comp | Comp | Comp |
|---|---|---|---|---|---|---|---|---|---|---|---|---|
| composition, gram | | Ex 1 | Ex 2 | Ex 3 | Ex 4 | Ex 5 | Ex 6 | Ex 7 | Ex 8 | Ex A | Ex C | Ex D |
| Monomer | AAEM | 270 | 135 | 270 | 270 | 270 | 270 | 270 | 270 | 270 | 270 | 270 |
| | ST | 0 | 135 | 0 | 0 | 0 | 0 | 0 | 0 | 0 | 0 | 0 |
| | DVB | 180 | 180 | 160 | 160 | 160 | 160 | 180 | 120 | 180 | 180 | 180 |
| | TRIM | 0 | 0 | 20 | 20 | 20 | 20 | 0 | 60 | 0 | 0 | 0 |
| Porogen | DIBK | 300 | 300 | 300 | 300 | 300 | 300 | 365 | 300 | 300 | 300 | 300 |
| Initiator | LPO | 4.5 | 4.5 | 4.5 | 4.5 | 4.5 | 4.5 | 0 | 4.5 | 4.5 | 4.5 | 4.5 |
| | BPO | 0 | 0 | 0 | 0 | 0 | 0 | 4.5 | 0 | 0 | 0 | 0 |
| PS foam | | 0 | 0 | 0 | 0 | 0 | 0 | 0 | 30 | 0 | 0 | 0 |
| Amine | PEI 2275 | 27 | 27 | | | 27 | 27 | 27 | 27 | | | |
| | PEI 1810 | | | 13.5 | 27 | | | | | | | |
| | Ammonia | | | | | | | | | | 100 | |
| | (27%) | | | | | | | | | | | |
| | AMP-95 | | | | | | | | | | | 30 |
| | (95%) | | | | | | | | | | | |

| | | | | | | | | | | | |
|---|---|---|---|---|---|---|---|---|---|---|---|
| Stirring rate (rpm) | 200 | 200 | 200 | 200 | 200 | 200 | 150 | 125 | 200 | 200 | 200 |

TABLE 2
Properties of Polymeric Beads

| | Number average | Specific surface area |
|---|---|---|
| | particle size (μm) | (BET method) (m²/g) |
| Ex 1 | 286 | 118 |
| Ex 2 | 328 | 121 |
| Ex 3 | 310 | 117 |
| Ex 4 | 310 | 117 |
| Ex 5 | 294 | 115 |
| Ex 6 | 311 | 109 |
| Ex 7 | 520 | 135 |
| Ex 8 | 2,540 | 45 |
| Comp Ex A | 287 | 115 |
| Comp Ex C | 286 | 118 |
| Comp Ex D | 286 | 118 |

Tables 3.1, 3.2 and 3.3 give FA abatement rate for inventive and comparative samples, respectively. For each sample, activated carbon was tested as a control in parallel to amine modified or un-modified polymeric beads, for example, “AC of Comp Ex A” represents activated carbon as a control sample for the polymeric beads of Comp Ex A. Higher CADR value indicates higher FA abatement rate.

As shown in Table 3.1, the polymeric beads of Exs 1 and 4-6 showed higher FA abatement rate (CADR value) and the polymeric beads of Exs 2, 3, and 7 showed comparable FA abatement rate, as compared to activated carbon.

As shown in Table 3.2, the un-modified beads of Comp Ex A exhibited much lower FA abatement rate than activated carbon. Ammonia treatment of polymer beads had no effect on FA abatement rate (Comp Ex C vs AC of Comp Ex C). This associated with low boiling point evaporation of ammonia during drying process (90° C.). Moreover, AMP-95 treated polymeric beads demonstrated similar FA abatement rate to activated carbon (Comp Ex D vs AC of Comp Ex D), this should be due to its higher boiling point than ammonia. However, AMP-95 tends to evaporate slowly at room temperature caused by the hydrolysis of enamine bonds, so AMP-95 is not suitable for home appliances.

As shown in Table 3.3, the results indicate that the ultra-large beads of Ex 8 had a higher FA abatement rate than AC with similar size.

TABLE 3.1
FA abatement rate tests by mini-chamber (Exs 1-7)

| | Concentration of FA at different time point (mg/m³) | | | | | | | | | | | |
|---|---|---|---|---|---|---|---|---|---|---|---|---|
| | AC | | AC | | AC | | | AC | | | AC | |
| Duration | of Ex | | of Ex | | of Ex | | | of Ex | | | of Ex | |
| (min) | 1 | Ex 1 | 2 | Ex 2 | 3&4 | Ex 3 | Ex 4 | 5&6 | Ex 5 | Ex 6 | 7 | Ex 7 |
| 0 | 0.84 | 0.84 | 0.84 | 0.84 | 0.83 | 0.84 | 0.85 | 0.83 | 0.84 | 0.84 | 0.8 | 0.81 |
| 1 | 0.81 | 0.8 | 0.81 | 0.84 | 0.83 | 0.83 | 0.84 | 0.8 | 0.81 | 0.83 | 0.79 | 0.79 |
| 2 | 0.77 | 0.76 | 0.79 | 0.81 | 0.77 | 0.79 | 0.8 | 0.77 | 0.8 | 0.79 | 0.75 | 0.75 |
| 3 | 0.73 | 0.72 | 0.75 | 0.77 | 0.73 | 0.75 | 0.75 | 0.73 | 0.76 | 0.73 | 0.7 | 0.7 |
| 4 | 0.69 | 0.68 | 0.7 | 0.73 | 0.69 | 0.7 | 0.7 | 0.68 | 0.7 | 0.69 | 0.65 | 0.65 |
| 5 | 0.65 | 0.64 | 0.65 | 0.69 | 0.65 | 0.66 | 0.66 | 0.64 | 0.65 | 0.64 | 0.61 | 0.61 |
| 6 | 0.62 | 0.6 | 0.62 | 0.65 | 0.61 | 0.62 | 0.61 | 0.61 | 0.62 | 0.6 | 0.57 | 0.58 |
| 7 | 0.58 | 0.56 | 0.57 | 0.62 | 0.57 | 0.58 | 0.58 | 0.56 | 0.57 | 0.56 | 0.53 | 0.54 |
| 8 | 0.56 | 0.53 | 0.54 | 0.58 | 0.54 | 0.56 | 0.53 | 0.53 | 0.54 | 0.52 | 0.5 | 0.52 |
| 9 | 0.53 | 0.5 | 0.5 | 0.56 | 0.5 | 0.53 | 0.49 | 0.5 | 0.49 | 0.49 | 0.46 | 0.49 |
| 10 | 0.49 | 0.46 | 0.48 | 0.53 | 0.49 | 0.5 | 0.46 | 0.46 | 0.46 | 0.45 | 0.44 | 0.45 |
| 15 | 0.38 | 0.34 | 0.36 | 0.42 | 0.37 | 0.37 | 0.33 | 0.34 | 0.32 | 0.33 | 0.33 | 0.34 |
| 20 | 0.3 | 0.25 | 0.28 | 0.33 | 0.29 | 0.29 | 0.24 | 0.26 | 0.24 | 0.24 | 0.25 | 0.26 |
| 25 | 0.24 | 0.2 | 0.21 | 0.26 | 0.22 | 0.22 | 0.18 | 0.21 | 0.16 | 0.18 | 0.2 | 0.21 |
| 30 | 0.18 | 0.14 | 0.17 | 0.22 | 0.18 | 0.18 | 0.13 | 0.17 | 0.12 | 0.13 | 0.16 | 0.17 |
| 35 | 0.16 | 0.12 | 0.13 | 0.18 | 0.14 | 0.14 | 0.1 | 0.13 | 0.08 | 0.1 | 0.13 | 0.13 |
| 40 | 0.13 | 0.09 | 0.12 | 0.16 | 0.13 | 0.12 | 0.08 | 0.1 | 0.05 | 0.08 | 0.1 | 0.12 |
| 45 | 0.1 | 0.08 | 0.09 | 0.13 | 0.12 | 0.1 | 0.06 | 0.09 | 0.04 | 0.06 | 0.09 | 0.1 |
| 50 | 0.09 | 0.06 | 0.09 | 0.1 | 0.09 | 0.08 | 0.04 | 0.08 | 0.01 | 0.05 | 0.08 | 0.09 |
| 55 | 0.08 | 0.05 | 0.06 | 0.09 | 0.08 | 0.06 | 0.02 | 0.06 | 0.01 | 0.02 | 0.08 | 0.08 |
| 60 | 0.06 | 0.04 | 0.06 | 0.06 | 0.08 | 0.05 | 0.02 | 0.05 | 0 | 0.02 | 0.06 | 0.06 |
| CADR | 0.0107 | 0.0125 | 0.0112 | 0.0103 | 0.0102 | 0.0115 | 0.0153 | 0.0115 | 0.0158 | 0.0150 | 0.0108 | 0.0105 |
| (m³/hour) | | | | | | | | | | | | |

*AC used in this table was the AC of Comp Ex B-1.

TABLE 3.2
FA abatement rate test by mini-chamber (comparative polymeric beads)

| | Concentration of FA at different time point (mg/m³) | | | | | |
|---|---|---|---|---|---|---|
| Duration | AC of Comp | | AC of Comp | | AC of Comp | |
| (min) | Ex A | Comp Ex A | Ex C | Comp Ex C | Ex D | Comp Ex D |
| 0 | 0.83 | 0.83 | 0.84 | 0.84 | 0.84 | 0.83 |
| 1 | 0.8 | 0.8 | 0.81 | 0.83 | 0.83 | 0.83 |
| 2 | 0.76 | 0.79 | 0.77 | 0.81 | 0.81 | 0.80 |
| 3 | 0.72 | 0.77 | 0.75 | 0.8 | 0.77 | 0.76 |
| 4 | 0.68 | 0.76 | 0.72 | 0.77 | 0.73 | 0.72 |
| 5 | 0.64 | 0.75 | 0.69 | 0.76 | 0.7 | 0.69 |
| 6 | 0.6 | 0.73 | 0.66 | 0.75 | 0.66 | 0.65 |
| 7 | 0.56 | 0.72 | 0.64 | 0.73 | 0.64 | 0.62 |
| 8 | 0.53 | 0.7 | 0.61 | 0.72 | 0.61 | 0.60 |
| 9 | 0.5 | 0.68 | 0.58 | 0.7 | 0.57 | 0.57 |
| 10 | 0.48 | 0.68 | 0.56 | 0.69 | 0.54 | 0.54 |
| 15 | 0.36 | 0.61 | 0.48 | 0.64 | 0.44 | 0.44 |
| 20 | 0.26 | 0.56 | 0.41 | 0.58 | 0.36 | 0.36 |
| 25 | 0.2 | 0.52 | 0.36 | 0.54 | 0.29 | 0.30 |
| 30 | 0.16 | 0.48 | 0.32 | 0.49 | 0.25 | 0.26 |
| 35 | 0.12 | 0.42 | 0.29 | 0.46 | 0.21 | 0.22 |
| 40 | 0.1 | 0.4 | 0.26 | 0.44 | 0.18 | 0.20 |
| 45 | 0.08 | 0.36 | 0.24 | 0.4 | 0.17 | 0.18 |
| 50 | 0.06 | 0.33 | 0.22 | 0.37 | 0.14 | 0.17 |
| 55 | 0.05 | 0.3 | 0.21 | 0.34 | 0.13 | 0.16 |
| 60 | 0.05 | 0.28 | 0.2 | 0.33 | 0.13 | 0.14 |
| CADR | 0.0121 | 0.0043 | 0.0060 | 0.0038 | 0.0083 | 0.0076 |
| (m³/hour) | | | | | | |

*AC used in this table was the AC of Comp Ex B-1.

TABLE 3.3
FA abatement rate test by mini-chamber (Ex 8)

| | Concentration of FA at different time point (mg/m³) | |
|---|---|---|
| Duration (min) | AC of Ex 8 | Ex 8 |
| 0 | 0.83 | 0.80 |
| 1 | 0.83 | 0.79 |
| 2 | 0.8 | 0.76 |
| 3 | 0.79 | 0.73 |
| 4 | 0.76 | 0.72 |
| 5 | 0.75 | 0.69 |
| 6 | 0.73 | 0.66 |
| 7 | 0.7 | 0.65 |
| 8 | 0.69 | 0.64 |
| 9 | 0.68 | 0.61 |
| 10 | 0.66 | 0.58 |
| 15 | 0.58 | 0.52 |
| 20 | 0.52 | 0.45 |
| 25 | 0.46 | 0.40 |
| 30 | 0.42 | 0.36 |
| 35 | 0.37 | 0.32 |
| 40 | 0.34 | 0.29 |
| 45 | 0.32 | 0.26 |
| 50 | 0.29 | 0.24 |
| 55 | 0.26 | 0.21 |
| 60 | 0.24 | 0.20 |
| CADR (m³/hour) | 0.0051 | 0.0057 |

*AC used in this table was the AC of Comp Ex B-2.

Table 4 gives results of performance stability of FA abatement of the polymeric beads of Ex 1 after aging at 85° C./85% humidity for 19 days, as determined by the mini-chamber method. Activated carbon was used as a control sample during the aging test. FA abatement rates of activated carbon and Ex 1 at different days were recorded, respectively. For example, “AC for Day 1” represents for activated carbon used as a control sample for Ex 1 after aging for 1 day, and “Ex 1 of day 5” refers to Ex 1 sample aged for 5 days. For each test, a fresh AC sample was used as a control. The results in Table 4 shows that the polymeric beads of Ex 1 after aging for 19 days didn't show an obvious decrease of FA abatement performance as compared to the polymeric beads after aging for 1 day, and still better than fresh AC.

TABLE 4
FA abatement rate test after accelerated aging

| | Concentration of FA at different time point (mg/m³) | | | | | | | |
|---|---|---|---|---|---|---|---|---|
| Duration | AC for | Ex 1 of | AC for | Ex 1 | AC for | Ex 1 of | AC for | Ex 1 of |
| (min) | day 1 | day 1 | day 5 | day 5 | day 11 | day 11 | day 19 | day 19 |
| 0 | 0.84 | 0.84 | 0.85 | 0.83 | 0.84 | 0.83 | 0.81 | 0.79 |
| 1 | 0.81 | 0.8 | 0.81 | 0.79 | 0.83 | 0.8 | 0.8 | 0.76 |
| 2 | 0.77 | 0.76 | 0.77 | 0.75 | 0.79 | 0.76 | 0.77 | 0.72 |
| 3 | 0.73 | 0.72 | 0.73 | 0.69 | 0.75 | 0.74 | 0.73 | 0.68 |
| 4 | 0.69 | 0.68 | 0.69 | 0.65 | 0.7 | 0.68 | 0.7 | 0.65 |
| 5 | 0.65 | 0.64 | 0.65 | 0.61 | 0.68 | 0.64 | 0.66 | 0.61 |
| 6 | 0.62 | 0.6 | 0.61 | 0.57 | 0.64 | 0.61 | 0.64 | 0.57 |
| 7 | 0.58 | 0.56 | 0.58 | 0.54 | 0.6 | 0.58 | 0.61 | 0.54 |
| 8 | 0.56 | 0.53 | 0.56 | 0.5 | 0.57 | 0.56 | 0.58 | 0.52 |
| 9 | 0.53 | 0.5 | 0.53 | 0.49 | 0.54 | 0.53 | 0.56 | 0.49 |
| 10 | 0.49 | 0.46 | 0.49 | 0.45 | 0.52 | 0.5 | 0.53 | 0.46 |
| 15 | 0.38 | 0.34 | 0.38 | 0.34 | 0.41 | 0.41 | 0.44 | 0.36 |
| 20 | 0.3 | 0.25 | 0.3 | 0.26 | 0.32 | 0.33 | 0.36 | 0.28 |
| 25 | 0.24 | 0.2 | 0.25 | 0.21 | 0.26 | 0.29 | 0.3 | 0.24 |
| 30 | 0.18 | 0.14 | 0.21 | 0.17 | 0.22 | 0.24 | 0.25 | 0.2 |
| 35 | 0.16 | 0.12 | 0.18 | 0.13 | 0.2 | 0.21 | 0.22 | 0.17 |
| 40 | 0.13 | 0.09 | 0.16 | 0.1 | 0.17 | 0.2 | 0.2 | 0.14 |
| 45 | 0.1 | 0.08 | 0.13 | 0.09 | 0.14 | 0.18 | 0.17 | 0.13 |
| 50 | 0.09 | 0.06 | 0.12 | 0.08 | 0.13 | 0.17 | 0.16 | 0.12 |
| 55 | 0.08 | 0.05 | 0.1 | 0.06 | 0.12 | 0.16 | 0.14 | 0.1 |
| 60 | 0.06 | 0.04 | 0.09 | 0.05 | 0.1 | 0.14 | 0.13 | 0.09 |
| CADR | 0.0107 | 0.0125 | 0.0092 | 0.0114 | 0.0067 | 0.0073 | 0.0077 | 0.0090 |
| (m³/hour) | | | | | | | | |

*AC used in this table was the AC of Comp Ex B-1.

Table 5.1 and 5.2 give properties of FA abatement capacity of Exs 1 and 7, and activated carbon, as determined by the testing tube method. FA abatement capacity is another important property of FA abatement material used in air purifiers, which means the total amount of FA can be abated and is desired to be as large as possible through the service life of the material.

For each example, after testing its FA abatement capacity performance, the sample was further tested for FA abatement rate by the mini-chamber method, in order to evaluate whether the FA abatement rate of the sample drops after abating a certain amount of FA. Such result can be used as an indicator of durability of the sample to abate FA.

As shown in Table 5.1, the results indicates that the FA abatement capacity of Ex 1 was about 30% higher than that of activated carbon. After the FA abatement capacity test, a mini-chamber test was conducted again on the same tested sample to measure CADR values in order to observe changes of CADR values in comparison with the corresponding AC. Results are given in Table 5.2. As shown in Table 5.2, the results showed that the polymeric beads of Ex 1, even after absorbing 30% more FA than activated carbon sample, still provided similar CADR value as AC.

TABLE 5.1
Properties of FA abatement capacity (testing tube method)

| | Ex 1 | | AC | |
|---|---|---|---|---|
| | Average FA | Abated FA at | Average FA | Abated FA at |
| | concentration | different time | concentration | different time |
| Time (min) | (mg/m³) | slot (μg) | (mg/m³) | slot (μg) |
| 0 | 0.75 | | 0.75 | |
| 20 | 0.20 | 2.2 | 0.32 | 1.7 |
| 40 | 0.26 | 4.2 | 0.37 | 3.3 |
| 60 | 0.30 | 3.8 | 0.39 | 2.9 |
| 80 | 0.21 | 3.9 | 0.43 | 2.7 |
| 100 | 0.35 | 3.8 | 0.45 | 2.5 |
| 120 | 0.39 | 3.1 | 0.47 | 2.3 |
| 140 | 0.43 | 2.7 | 0.47 | 2.2 |
| 160 | 0.45 | 2.5 | 0.47 | 2.2 |
| 180 | 0.46 | 2.4 | 0.50 | 2.1 |
| 200 | 0.49 | 2.2 | 0.72 | 1.1 |
| 220 | 0.83 | 0.7 | 0.69 | 0.4 |
| Total abated FA (μg) | | 31.5 | | 23.5 |

*AC used in this table was the AC of Comp Ex B-1.

TABLE 5.2
CADR values of Ex 1 and AC before and after absorbing certain amount of FA

| | CADR value | Absorbed FA | CADR value after |
|---|---|---|---|
| | before testing tube | (μg) by testing | testing tube method |
| | method (m³/hour) | tube method | (m³/hour) |
| AC | 0.0107 | 23.5 | 0.0045 |
| Ex 1 | 0.0125 | 31.5 | 0.0048 |
| CADR ratio* of Ex 1 vs AC | 117% | | 107% |

*CADR ratio = CADR value of Ex 1/CADR value of activated carbon × 100%

Comparison of FA abatement capacity of Ex 7 and activated carbon is shown in Table 6.1. The results in Table 6.1 showed that the FA abatement capacity of Ex 7 was about 50% higher than that of activated carbon sample within 260 minutes. After the FA abatement capacity test, a mini-chamber test was conducted again on the same tested sample to measure CADR values in order to observe changes of CADR values in comparison with the corresponding activated carbon sample, and results are given in Table 6.2. As shown in Table 6.2, even after absorbing more FA, the polymeric beads of Ex 7 still demonstrated the CADR value 45% higher than corresponding activated carbon.

As shown in Table 6.3, the total amount of FA abated by the polymeric beads of Ex 8 was higher than that of the comparative AC, which indicates that Ex 8 provided higher FA abatement capacity than AC. Moreover, AC failed to abate FA after 180 minutes of testing while the polymeric beads of Ex 8 still abated FA after 300 minutes.

TABLE 6.1
FA abatement capacity properties of Ex 7 and AC (testing tube method)

| | Ex 7 | | AC | |
|---|---|---|---|---|
| | | abated FA (μg) | | abated FA (μg) |
| | Average FA | at different time | Average FA | at different time |
| Time (min) | conc. (mg/m³) | slot | conc. (mg/m³) | slot |
| 0 | 0.75 | | 0.75 | |
| 20 | 0.16 | 2.36 | 0.33 | 1.68 |
| 40 | 0.07 | 5.06 | 0.20 | 3.86 |
| 60 | 0.07 | 5.42 | 0.22 | 4.31 |
| 80 | 0.11 | 5.26 | 0.34 | 3.76 |
| 100 | 0.16 | 4.92 | 0.41 | 2.97 |
| 120 | 0.19 | 4.60 | 0.45 | 2.54 |
| 140 | 0.19 | 4.48 | 0.39 | 2.64 |
| 160 | 0.18 | 4.54 | 0.35 | 3.02 |
| 180 | 0.20 | 4.48 | 0.38 | 3.05 |
| 200 | 0.23 | 4.29 | 0.40 | 2.86 |
| 220 | 0.28 | 4.00 | 0.46 | 2.54 |
| 240 | 0.32 | 3.61 | 0.51 | 2.11 |
| 260 | 0.33 | 3.39 | 0.50 | 1.95 |
| Total abated FA (μg) | | 56.40 | | 37.30 |

*AC used in this table was the AC of Comp Ex B-1.

TABLE 6.2
CADR values of Ex 7 and AC before and after absorbing certain amount of FA

| | CADR value before | Absorbed FA | CADR value after |
|---|---|---|---|
| | testing tube method | (μg) by testing | testing tube |
| | (m³/hour) | tube method | method (m³/hour) |
| AC | 0.0108 | 37.3 | 0.0062 |
| Ex 7 | 0.0105 | 56.4 | 0.0090 |
| CADR ratio of Ex 7 vs AC | 97% | | 145% |

*AC used in this table was the AC of Comp Ex B-1
CADR ratio = CADR value of Ex 7/CADR value of activated carbon × 100%

TABLE 6.3
FA abatement capacity properties of Ex 8 and AC (testing tube method)

| | AC | | Ex 8 | |
|---|---|---|---|---|
| | Average FA | Abated FA at | Average FA | Abated FA at |
| | concentration | different time | concentration | different time |
| Time (min) | (mg/m³) | slot (μg) | (mg/m³) | slot (μg) |
| 0 | 1.00 | | 1.00 | |
| 10 | 0.74 | 0.5 | 0.82 | 0.4 |
| 20 | 0.74 | 1.0 | 0.96 | 0.4 |
| 30 | 0.61 | 1.3 | 0.79 | 0.5 |
| 40 | 0.56 | 1.7 | 0.87 | 0.7 |
| 50 | 0.57 | 1.7 | 0.82 | 0.6 |
| 60 | 0.59 | 1.7 | 0.74 | 0.9 |
| 70 | 0.62 | 1.6 | 0.71 | 1.1 |
| 80 | 0.65 | 1.5 | 0.68 | 1.2 |
| 90 | 0.67 | 1.4 | 0.68 | 1.3 |
| 100 | 0.68 | 1.3 | 0.69 | 1.3 |
| 110 | 0.67 | 1.3 | 0.71 | 1.2 |
| 120 | 0.69 | 1.3 | 0.72 | 1.1 |
| 130 | 0.71 | 1.2 | 0.75 | 1.1 |
| 140 | 0.77 | 1.0 | 0.76 | 1.0 |
| 150 | 0.76 | 0.9 | 0.78 | 0.9 |
| 160 | 0.83 | 0.8 | 0.80 | 0.8 |
| 170 | 0.94 | 0.4 | 0.81 | 0.8 |
| 180 | 1.06 | | 0.83 | 0.7 |
| 190 | | | 0.83 | 0.7 |
| 200 | | | 0.84 | 0.7 |
| 210 | | | 0.83 | 0.7 |
| 220 | | | 0.83 | 0.7 |
| 230 | | | 0.83 | 0.7 |
| 240 | | | 0.84 | 0.7 |
| 250 | | | 0.86 | 0.6 |
| 260 | | | 0.87 | 0.5 |
| 270 | | | 0.90 | 0.5 |
| 280 | | | 0.90 | 0.4 |
| 290 | | | 0.93 | 0.3 |
| 300 | | | 0.95 | 0.2 |
| Total abated FA (μg) | | 20.7 | | 22.6 |

*AC used in this table was the AC of Comp Ex B-2.

What is claimed is:

1. Polyethylenimine coated polymeric beads comprising a polymer, wherein the polymer comprises, based on the weight of the polymer,
from 25% to 75% by weight of structural units of an acetoacetoxy or acetoacetamide functional monomer, and
from 25% to 75% by weight of structural units of a polyvinyl monomer;
wherein the polyethylenimine has a number average molecular weight of 300 g/mol or more; and
wherein the polyethylenimine coated polymeric beads have a specific surface area in the range of from 20 to 400 m²/g.

2. The polyethylenimine coated polymeric beads of claim 1, wherein the polymeric beads have a specific surface area in the range of from 40 to 250 m²/g.

3. The polyethylenimine coated polymeric beads of claim 1, wherein the polyethylenimine has a structure of formula (II), 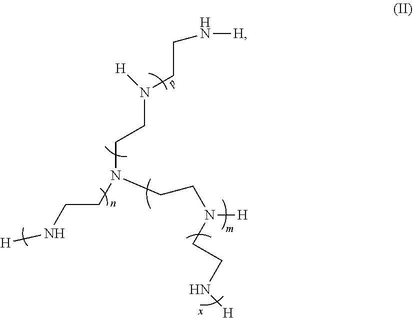
where n, m, p, and x are each independently an integer of from 0 to 1,000, provided that n+m+p+x>5.

4. The polyethylenimine coated polymeric beads of claim 1, wherein the number average molecular weight of the polyethylenimine is in the range of from 300 to 10,000 g/mol.

5. The polyethylenimine coated polymeric beads of claim 1, wherein the acetoacetoxy or acetoacetamide functional monomer is selected from the group consisting of acetoacetoxyethyl methacrylate, acetoacetoxyethyl acrylate, acetoacetoxypropyl methacrylate, allyl acetoacetate, acetoacetoxybutyl methacrylate, and 2,3-di(acetoacetoxy)propyl methacrylate.

6. The polyethylenimine coated polymeric beads of claim 1, wherein the polyvinyl monomer is selected from the group consisting of divinylbenzene, trivinyl benzene, divinylnaphthalene, trimethylolpropane trimethacrylate, allyl (meth)acrylate, tripropylene glycol dimethacrylate, diethylene glycol dimethacrylate, ethylene glycol di(meth)acrylate, 1,6-hexanediol di(meth)acrylate, 1,3-butylene glycol dimethacrylate, and 1,4-butylene glycol di(meth)acrylate.

7. The polyethylenimine coated polymeric beads of claim 1, wherein the polymer comprises, based on the weight of the polymer, from 30% to 70% by weight of structural units of the acetoacetoxy or acetoacetamide functional monomer, from 30% to 70% by weight of structural units of the polyvinyl monomer, and from 0 to 20% by weight of structural units of a monovinyl aromatic monomer.

8. The polyethylenimine coated polymeric beads of claim 1, having a number average particle size of from 200 to 5,000 μm.

9. A process for preparing the polyethylenimine coated polymeric beads of claim 1, comprising,
(i) suspension polymerization of monomers in the presence of a porogen, wherein the monomers comprise, based on the total weight of monomers,
from 25% to 75% by weight of an acetoacetoxy or acetoacetamide functional monomer, and
from 25% to 75% by weight of a polyvinyl monomer; and
(ii) contacting the obtained polymer from step (i) with a polyethylenimine to give the polyethylenimine coated polymeric beads;
wherein the polyethylenimine has a number average molecular weight of 300 g/mol or more; and
wherein the polyethylenimine coated polymeric beads have a specific surface area in the range of from 20 to 400 m²/g.

10. The process of claim 9, wherein the polyethylenimine is used in an amount of from 0.1% to 15%, by weight based on the weight of the polymer.

11. The process of claim 9, wherein the polyethylenimine has a structure of formula (II), 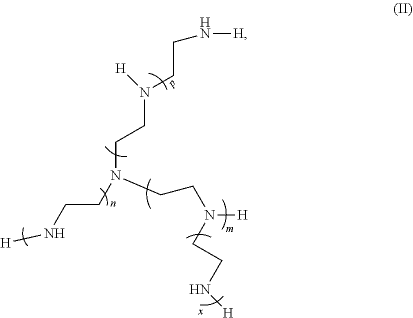
where n, m, p, and x are each independently an integer of from 0 to 1,000, provided that n+m+p+x>5.

12. The process of claim 9, wherein the number average molecular weight of the polyethylenimine is in the range of from 300 to 10,000 g/mol.

13. The process of claim 9, wherein the porogen is selected from the group consisting of diisobutyl ketone, toluene, butyl acetate, isooctane and methyl butyl ketone.

14. A gas filter device comprising the polyethylenimine coated polymeric beads of claim 1 as a filter medium.

15. A method of removing aldehydes from air containing aldehydes, comprising contacting the air with the polyethylenimine coated polymeric beads of claim 1.
